(19) United States
(12) Patent Application Publication
(10) Pub. No.: US 2010/0161333 A1
(43) Pub. Date: Jun. 24, 2010

(54) ADAPTIVE PERSONAL NAME GRAMMARS

(75) Inventors: MICHAEL T. MAAS, Shoreline, WA (US); KEVIN L. CHESTNUT, (US)

Correspondence Address: LAW OFFICE OF CHARLES E. KRUEGER, P.O. BOX 5607, WALNUT CREEK, CA, 94596-1607, US

(73) Assignee: CISCOTECHNOLOGY, INC, San Jose, CA (US)

(21) Appl. No.: 12/342,785

(22) Filed: Dec. 23, 2008

(51) Int. Cl. G10L 15/00

(52) U.S. Cl. 704/251; 704/E15.001

(57) ABSTRACT

In one embodiment, an adaptive personal name grammar improves speech recognition by limiting or weighting the scope of potential addressable names based upon meta-information relative to the communications patterns, environmental considerations, or sociological/professional hierarchy of a user to increase the likelihood of a positive match.

### TECHNICAL FIELD

The present disclosure relates generally to name grammars utilized in speech recognition systems to identify spoken names.

### BACKGROUND OF THE INVENTION

Speech recognition software can be utilized to analyze input in the form of spoken words and phrases and determine what has been said. Existing speech recognition software systems are not designed to recognize any possible utterance but are constrained by a grammar of recognizable word or phonetic patterns in order to provide reasonable response time and accuracy. These grammars are generally context sensitive. For example, an automobile control context might include a limited set of grammar definitions including entries for “start the engine” and “turn on the lights” where an airline application might include context-specific commands such as “what is the departure time of flight 788X?” or “i'd like to upgrade to first-class.”

Grammars are often created utilizing existing text definition descriptions such as Augmented Backus-Naur Form (ABNF), Grammar Syntax Language (GSL), and Speech Recognition Grammar Specification (SRGS). Each of these grammar formats specify how recognition grammars are defined. A common element between grammar definitions is that entries in the grammar may be assigned weights indicating the likelihood of the entry being spoken as an indicator to the speech recognition software to give more precedence or likelihood to certain words or phrases being returned as a result. Appropriate weights are difficult to determine and guessing weights does not always improve recognition performance because of gaps in expected behavior or usage between the designer of a system and the user of a system. Effective weights are usually obtained by study of real speech and result data collected from a system in use in its intended context.

Grammars involving names are a common special case in speech recognition in that the context is generally the same (identify a person or group of people by a name) but the content is almost certainly guaranteed to be unique for each implementation. For example, if two companies sell widgets through a speech recognition application, they might have commands in common like “buy a widget” or “i'd like help for my widget.” However, since each company may have different internal structures and employees, commands like “call Steve Jones” only make sense if the company has an employee named Steve Jones. Additionally, one company may refer to different processes or groups with different names, so one widget company might require “i'd like technical support” while the other requires “i'd like widget help.” These differences make it extremely difficult to identify weighting or probability structures for grammars that include things like personnel, department, or even location names.

### BRIEF DESCRIPTION OF THE DRAWINGS

FIG. 1 illustrates an example of table entries utilized in an example embodiment;

FIG. 2 illustrates a block diagram of an example embodiment;

FIG. 3 is a flow chart illustrating the operation of an example embodiment; and

FIG. 4 illustrates a block diagram of a system for implementing an example embodiment.

### DESCRIPTION OF EXAMPLE EMBODIMENTS OVERVIEW

An adaptive name grammar for a speech recognition system implements a user-specific personal name grammar definition having entries for a group of members with each entry including identification information that identifies an associated member of the group and with each entry including a weight or probability value indicating the likelihood of the name of the associated member being spoken. Environmental information is analyzed to determine group members likely to be contacted by the user and the weight value in an entry associated with a group member is altered to indicate the likelihood that the group member will be contacted by the user.

### Description

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention. Further, each appearance of the phrase an “example embodiment” at various places in the specification does not necessarily refer to the same example embodiment.

Using speech recognition to call, address, or otherwise identify people or groups of people by their spoken names is one of the more difficult problems to overcome in a voice user interface. This is because the number of names, complexity of their composition, variations in pronunciation, and external interference all factor into the ability to correctly match a name against a given audio input or utterance. In a global communications environment, the sheer number and diversity of names coupled with the allowable variation in individual pronunciation presents an enormous technical challenge.

An example embodiment will now be described that uses concepts from social interaction to dynamically adjust the accuracy of voice addressing by spoken name. By collecting user-specific contact and addressing information, work group structure, inter-personal communications, egress monitoring, and call history information that may exist within a messaging or corporate information system, the utterance resolution via speech recognition can be improved when calling or addressing to another user by name.

The operation of this embodiment will now be described in an example context of a user (User A) working in a corporate or other professional or social environment where user-specific contact and addressing information, work group structure, inter-personal communications, egress monitoring, and call history information exists within a corporate messaging and information system. In this example, the name grammar would include every employee of the corporation or business.

The following is a pseudo-example of activity for User A:
1. User A calls User B, this activity is noted and User B is weighted higher to be recognized more often. (User B +5)
2. User A leaves a (email|instant|voice) message for User C. User C is weighted higher as a result. (User C +4)
3. User A has User B in a custom or personal distribution list. User B is therefore more important and weighted higher. (User B +3)
4. User A has User D in a buddy list or similar construct. User D is weighted higher. (User D +2)
5. User A is in a regular or ad-hoc meeting with User D. User D should be weighted slightly higher. (User D +1)
6. User A is in the same physical location as Users B, C, and D. This fact should slightly increase the likelihood of User A calling Users B, C or D and should be weighted accordingly. (Users B, C, and D +1)
7. Users E, F, and G all report to User A. (Users E, F, and G +1)
8. A specified period of time has passed and all weights for a User are reduced by a small amount. (All Users −0.25)

Note that in this example there are three types of information utilized. The first is dynamic activity such as calling another user (item 1), leaving a message (item 2) or attending a meeting with another user (item 5). The second is social and environmental information such as the customer or personal distribution list (item 3), the buddy list (item 4), the physical location (item 6) and the reporting structure (item 7). The third is time. Weighting is degraded over time as communications and social interactions between Users vary in intensity over time. To keep weights current, communications activity between two entities must continue to be established. As shown in the list, different activities and different information may be assigned different weights based on their relative importance within the organization.

A subsequent constructed collection of addressable names or weighting improvements based on the operations described in the pseudo-example would result in the following for User A: +9 to User B; +5 to User C; +4 to User D; +1 to User E; +1 to User F; +1 to User G. Over time, if User A did not continue to contact other Users, their individual weighting improvements could slowly reset or normalize.

This small collection of commonly accessed or important members is an important consideration in resolving addressing relationships within large organizations with tens or even hundreds of thousands of individual contacts. It plays upon common ideas of repeated, regular and regulated social interactions between individuals to help shape voice recognition accuracy for names. Name recognition is improved by limiting or weighting the scope of potential addressable names based upon meta-information relative to the sociological hierarchy of a user, thereby increasing the likelihood of a positive match.

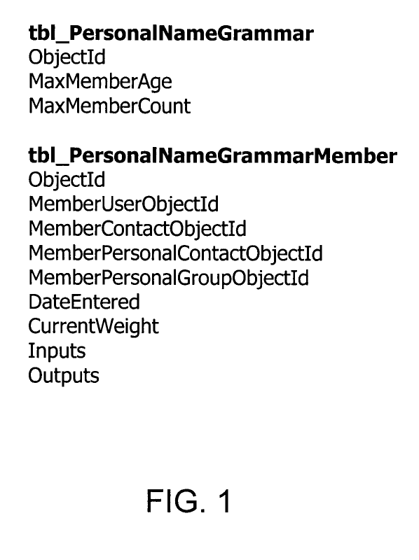

The operation of an example embodiment will now be described with reference to FIGS. 1-3. FIG. 1 depicts table entries for User A's personal name grammar, which includes a Personal Name Grammar entry and Personal Name Grammar Member entries.

In this example, each Personal Name Grammar Member entry in User A's personal name grammar includes different identifiers for the member, such as the member's identifier in the Personal Name Grammar system (ObjectId), the member's identifier in the phone call database (MemberUserObjectID), the member's identifier in the contact data base (MemberContactObjectID), the member's identifier in the personal contact database (MemberPersonalContactObjectID), and the member's identifier in the personal group database (MemberPersonalGroupObjectID). The Personal Name Grammar Member entry also includes information on the date the entry was entered (DateEntered), the current weight assigned to the member (CurrentWeight) and statistics (Inputs and Outputs).

There is a Personal Name Grammar entry for every member included in a user's personal name grammar that includes the member's identifier (ObjectId), the maximum age of any member entry in the user's personal grammar (MaxMemberAge) and the maximum number of entries in the user's personal grammar (MaxMemberCount).

The fields in the Personal Name Grammar entry are used for management purposes to control the age of entries in a user's personal name grammar so that stale entries can be removed (MaxMemberAge) and to limit the number of entries in the user's personal name grammar (MaxMemberCount).

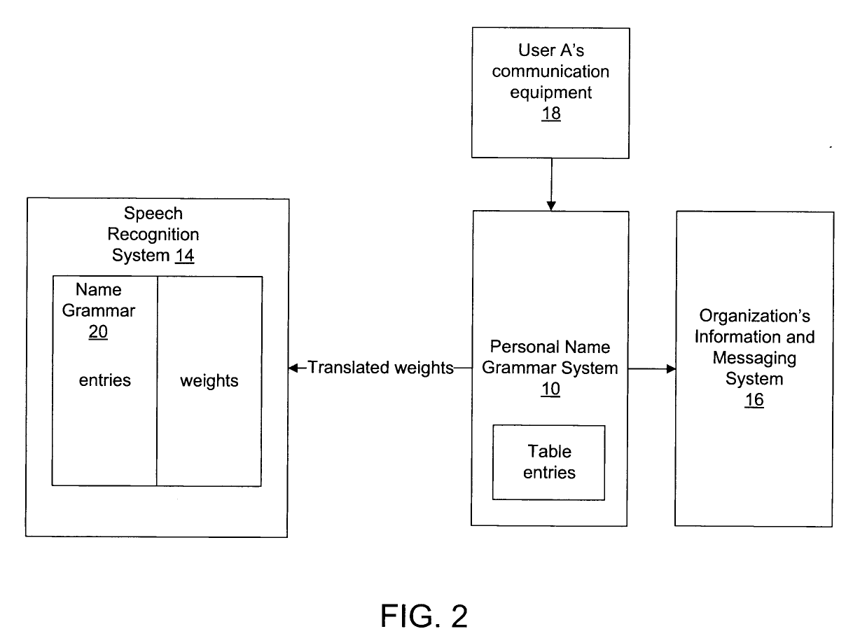

FIG. 2 is a schematic diagram of an example embodiment of the adaptive name grammar system. The personal name grammar system 10 is a software module coupled to the speech recognition system 14, the corporate information and messaging system 16 and the communication equipment 18 assigned to User A. The speech recognition system 14 includes the personal name grammar 20 holding the table entries depicted in FIG. 1.

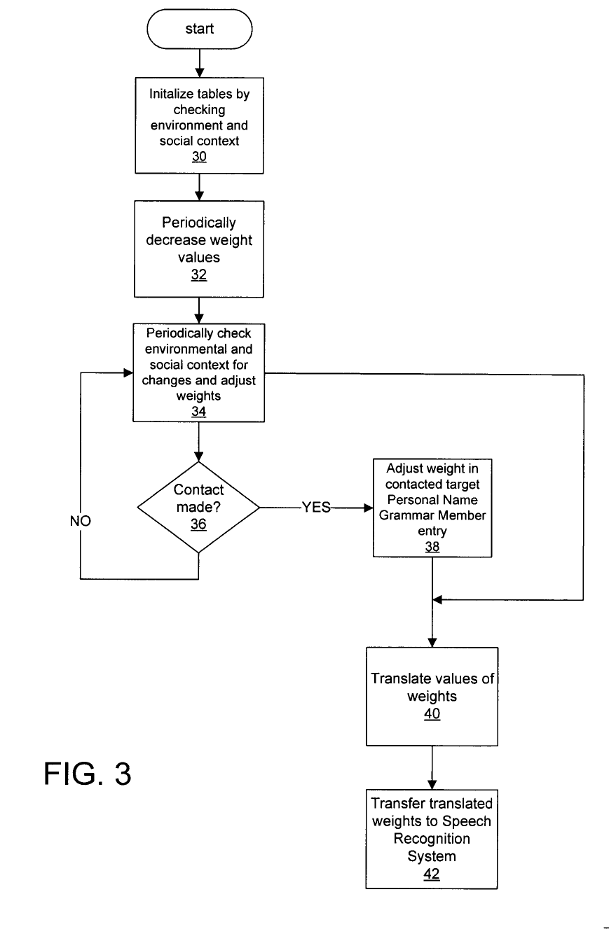

The operation of the example system depicted in FIG. 2 will now be described with reference to the flow chart of FIG. 3.

Upon startup the system is initialized and the tables are set up. The corporate information and messaging system is searched and table entries are created for members in User A's custom and distribution list (item 3 in the pseudo-example), in User A's buddy list (item 4), with whom User A has regular ad-hoc meetings (item 5), with members in the same physical location as User A (item 6) and with members who report to User A (item 6).

During initialization weights can be assigned to each member as described above in the context of the pseudo-example.

Subsequent to initialization, in the first step the environmental and social context for User A is rechecked for changes and table entries are updated or new table entries are created.

The personal name grammar system then monitors whether a call has been received by User A. If so, then User A's Personal Name Grammar Member Entry for the caller member has its weight adjusted (item 1) if the personal name grammar of User A includes a table entry for the caller target member. If there is no existing table entry for the caller target member then a table entry is created with the appropriate weight assigned.

The personal name grammar system then monitors whether a call has been made. If so, then User A's Personal Name Grammar Member Entry for the called target member has its weight adjusted (item 2) if the personal name grammar of User A includes a table entry for the called target member. If there is no existing table entry for the called target member then a table entry is created with the appropriate weight assigned.

The flow chart of FIG. 3 depicts the steps following sequentially in a loop-like structure. However, as understood by persons of skill in the art, an interrupt structure could also be utilized where any changes generate an interrupt which is serviced to implement the weighting functions described above.

Accordingly, the weights assigned to the different names in the name grammar of the speech recognition system have been adaptively adjusted to take into account the specific social interactions and environment of User A. Those members that are more likely to be contacted by User A have been assigned higher weight values so that when the speech recognition system attempts to recognize a name spoken by User A the search will be weighted towards members with whom User A has social or environmental contacts.

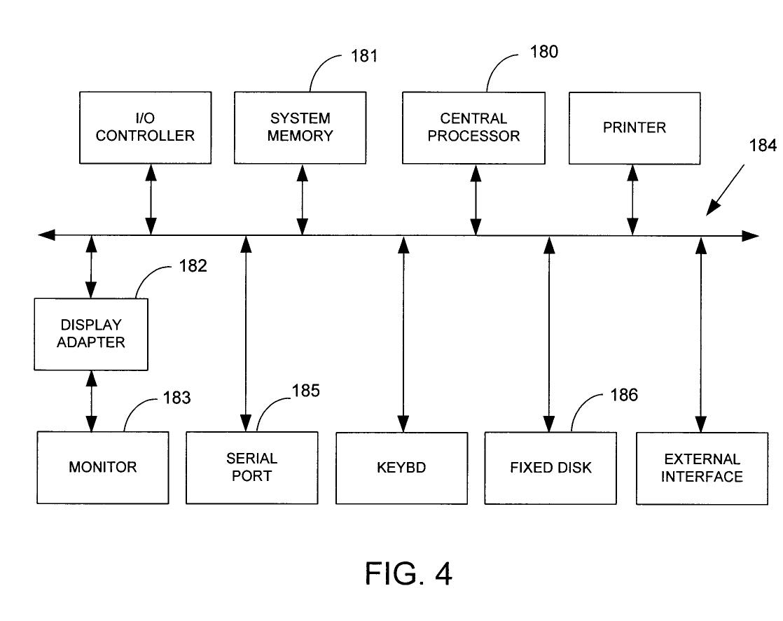

FIG. 4 is an illustration of basic subsystems in a computer system that can be utilized to implement an example embodiment. In FIG. 4, subsystems are represented by blocks such as central processor 180, system memory 181 consisting of random access memory (RAM) and/or read-only memory (ROM), display adapter 182, monitor 183, etc. The subsystems are interconnected via a system bus 184. Additional subsystems such as a printer, keyboard, fixed disk and others are shown. Peripherals and input/output (I/O) devices can be connected to the computer system by, for example, serial port 185. For example, serial port 185 can be used to connect the computer system to a modem for connection to a network, or serial port 185 can be used to interface with a mouse input device. The interconnection via system bus 184 allows central processor 180 to communicate with each subsystem and to control the execution of instructions from system memory 181 or fixed disk 186, and the exchange of information between subsystems. Other arrangements of subsystems and interconnections are possible.

The invention has now been described with reference to the example embodiments. Alternatives and substitutions will now be apparent to persons of skill in the art. For example, the structure of the table entries, the values of the weights assigned, and the types of meta-information searched are described by way of example, not limitation. Accordingly, it is not intended to limit the invention except as provided by the appended claims.

1. A method comprising:
creating a user-specific personal name grammar having entries for a group of members with each entry including identification information that identifies an associated member of the group and with each entry including a weight value indicating the likelihood of the name of the associated member being spoken;
analyzing environmental information to determine group members likely to be contacted by the user; and
altering the weight value in an entry associated with a group member to indicate the likelihood that the group member will be contacted by the user.

2. The method of claim 1 further comprising:
altering the weight value of an entry associated with a group member who contacts the user to indicate that a the contacting group member is more likely to be contacted by the user.

3. The method of claim 1 further comprising:
altering the weight value of an entry associated with a group member who is contacted by the user to indicated that a the contacted group member is more likely to be contacted by the user.

4. The method of claim 1 further comprising:
altering the weight value of an entry associated with a group member after expiration of a first selected time period to indicate that the group member is less likely to be contacted by the user.

5. The method of claim 1 where analyzing further comprises:
altering the weight value of an entry associated with a group member added to a social or environmental group of the user to indicate that the group member is more likely to be contacted by the user.

6. The method of claim 4 further comprising:
deleting a member's personal name grammar entry that has not been active for a second selected time period.

7. The method of claim 1 further comprising:
translating weight values held in personal name grammar entries to normalized weight values that can be used by a speech recognition system; and
transferring the normalized weight values to the speech recognition system.

8. An apparatus comprising:
a memory holding program code, personal name grammar entries, and environmental information;
a processor, coupled to said memory and configured execute program code to create a user-specific personal name grammar having entries for a group of members with each entry including identification information that identifies an associated member of the group and with each entry including a weight value indicating the likelihood of the name of the associated member being spoken; to analyze environmental information to determine group members likely to be contacted by the user;
and to alter the weight value in an entry associated with a group member to indicate the likelihood that the group member will be contacted by the user.

9. The apparatus of claim 8 with the processor further configured to execute program code to:
alter the weight value of an entry associated with a group member who contacts the user to indicate that a contacting group member is more likely to be contacted by the user.

10. The apparatus of claim 8 with the processor further configured to execute program code to:
alter the weight value of an entry associated with a group member who is contacted by the user to indicated that a contacted group member is more likely to be contacted by the user.

11. The apparatus of claim 8 with the processor further configured to:
alter the weight value of an entry associated with a group member after expiration of a first selected time period to indicate that a contacting group member is less likely to be contacted by the user.

12. The apparatus of claim 8 with the processor further configured to:
alter the weight value of an entry associated with a group member added to a social or environmental group of the user to indicate that a contacting group member is more likely to be contacted by the user.

13. The apparatus of claim 11 with the processor further configured to:
delete a member's personal name grammar entry that has not been active for a second selected time period.

14. The apparatus of claim 8 with the processor further configured to:
translate weight values held in personal name grammar entries to normalized weight values that can be used by a speech recognition system; and
transfer the normalized weight values to the speech recognition system.

15. One or more computer readable storage media encoded with software comprising computer executable instructions and with the software operable to:
create a user-specific personal name grammar having entries for a group of members with each entry including identification information that identifies an associated member of the group and with each entry including a weight value indicating the likelihood of the name of the associated member being spoken;
analyze environmental information to determine group members likely to be contacted by the user; and
alter the weight value in an entry associated with a group member to indicate the likelihood that the group member will be contacted by the user.

16. The computer readable storage media of claim 15 encoded with software when executed further operable to:
alter the weight value of an entry associated with a group member who is contacted by the user to indicated that a contacted group member is more likely to be contacted by the user.

17. The computer readable storage media of claim 15 encoded with software when executed further operable to:
alter the weight value of an entry associated with a group member after expiration of a first selected time period to indicate that a group member is less likely to be contacted by the user.

18. The computer readable storage media of claim 15 where the encoded software operable analyze is operable to:
alter the weight value of an entry associated with a group member added to a social or environmental group of the user to indicate that the group member is more likely to be contacted by the user.

19. The computer readable storage media of claim 17 encoded with software when executed further operable to:
delete a member's personal name grammar entry that has not been active for a second selected time period.

20. The computer readable storage media of claim 15 encoded with software when executed further operable to:
translate weight values held in personal name grammar entries to normalized weight values that can be used by a speech recognition system; and
transfer the normalized weight values to the speech recognition system.
